(19) United States
(12) Patent Application Publication
(10) Pub. No.: US 2009/0297352 A1
(43) Pub. Date: Dec. 3, 2009

(54) DEBRIS REMOVAL SYSTEM AND METHOD FOR WIND TURBINE BLADES

(75) Inventor: JOSEPH P. WALTER, Sun Prairie, WI (US)

Correspondence Address: MCKEE, VOORHEES & SEASE, P.L.C., 801 GRAND AVENUE, SUITE 3200, DES MOINES, IA, 50309-2721, US

(73) Assignee: ZULU-REVOLUTIONS, INC., Nauvoo, IL (US)

(21) Appl. No.: 12/129,856

(22) Filed: May 30, 2008

(51) Int. Cl. F03B 3/12

(52) U.S. Cl. 416/223 R

(57) ABSTRACT

A system is provided for cleaning debris from horizontal axis wind turbine blades. The system includes a wiper with arms extending partially around the blade adjacent the leading edge and a line engaging the leading edge so as to scrape debris from the blade edge as the arms move along the length of the blade. The arms are carried outwardly along the blades by aerodynamic and centripetal forces, and are retracted by cables attached to the arms. The system is activated by a PLC in response to sensors on the turbine to automatically clean the blade when wind conditions typically allow insects to fly and contaminate the blades. A grease control system is also provided on the blades to prevent grease or oil from the turbine hub from leaking onto the blade.

### FIELD OF THE INVENTION

The invention is directed towards a system and method for removing debris from the leading edge surfaces of horizontal axis wind turbine (HAWT) blades, so as to enable the turbine to operate at design specification performance by eliminating power generation losses due to contamination of the turbine blades. The invention is also directed towards a system and method for preventing grease and oil accumulation on HAWT blades. The systems and methods of the invention can be used on all types of HAWTs, including stall controlled-passive (fixed pitch), stall controlled-active (variable pitch towards stall), pitch controlled (variable pitch towards feather), and variable RPM (constant tip-speed ratio and angle of attack).

### BACKGROUND OF THE INVENTION

The aerodynamic performance of wind turbine blades can be affected by surface finish of the blades. The magnitude by which surface finish affects aerodynamic performance of a turbine blade airfoil is referred to as the surface roughness sensitivity of the airfoil. Development of special purpose airfoils for HAWTs began in 1984 to improve aerodynamic efficiency and reduce surface roughness sensitivity. Estimated annual losses due to surface roughness ranged from 5%-30%, depending on the HAWT type. More recent airfoil designs for HAWT blades reduces the sensitivity by approximately 50% from previously used airfoils, though estimated annual losses due to surface roughness still remains at 2.5%-15%, depending on the type of HAWT.

Surface roughness losses on HAWT blades are most commonly caused by contamination in the form of debris deposits accumulated during operation. These deposits are composed of insect carcasses, soil particles, grease and oil leakage from the HAWT hub and gearbox. Surface roughness may also include the surface condition due to manufacture or wear over time.

The current method for removing debris deposits from HAWT blades is to manually wash the blades using water and a solvent. Such manual washing requires that the HAWT cease operation. This manual cleaning process typically requires 6 to 8 hours to accomplish for each HAWT. Furthermore, equipment, such as a large lift, is required for this manual labor debris removal process. Thus, the costs for removing the debris from the HAWT blades includes the value of potential energy production lost during the cleaning time, the cost of labor, and the cost of the equipment and supplies. In particular operating conditions, contamination in the form of debris deposits may accumulate after a very short time following the manual washing, thereby negating the desired performance effect of the manual washing. Therefore, another cost of using manual washing or not washing the blades includes reduced annual power production from periods of operating with blades at less than design performance due to debris deposits.

The losses due to debris deposits are proportional to the amount of debris deposits on the blade, as well as the wind speed. Blade contamination degrades performance of the HAWT significantly at higher wind speeds, and somewhat negligibly at lower speeds. This wind speed effect of blade debris is depicted in FIG. 15, which displays the power generation output of a turbine with debris-free clean blades, as opposed to contaminated blades. Since the energy content of wind is proportional to the cube of wind speed, degraded performance at higher wind speeds can have a significant impact on wind turbine power production. Therefore, although losses may be negligible during lower wind speed operation, operation of the HAWT with contaminated blades can result in significant losses during higher wind speed conditions, resulting in estimated annual power production losses of 2.5%-15%. An analogous situation exists with sailplane wings, which are subject to degradation in glide performance resulting from debris contamination, such as the deposit of insect or “bug” carcasses. The degradation in glide performance may range from 5%-15% due to bugs on the leading edge of the wings. The use of “bug wipers” on sailplane wings is a proven technology.

FIGS. 16A-16C depicts a conventional sailplane wing 100 with a bug wiper 110. The bug wipers 110 have a pair of C-shaped plates 112, 114 which are connected by spring hinges so as to be moveable between a collapsed, closed position wherein the plates are closely spaced, to an open V-configuration. The outboard plate 112 is larger in area than the inboard plate 114, which causes the wiper 110 to slide outward along the wing's leading edge from the wing root to wing tip during flight due to aerodynamic force on the plates. The aerodynamic forces on the open plates also forces the bug wiper 110 against the leading edge 118 of the wing 100 during flight. A nylon string 120 is connected at opposite ends to the plates 112, 114 so as to engage the leading edge 118 of the wing 100, while also limiting the opening “V” angle between the plates, as driven by the plate connecting spring hinges. As the wiper 110 slides along the wing 100, the nylon line 120 scrapes off bugs that have impacted the leading edge. An additional nylon line 122 is connected at one end to the fuselage, near the root of the wing 100 and at the other end to the wiper 110, so as to prevent the wiper from flying off the end of the wing. Thus, the control line 122 permits the wiper 110 to travel to the end of the wing 100, and then is used to reel the wiper back to the fuselage. The control lines from each wing are routed from holes in the fuselage at the wing roots to the cockpit, where the control lines are attached to fly fishing pole reels. When the inboard plate 114 reaches the fuselage, continued reeling of the line 122 forces the plates to collapse against the connecting spring hinges from the open V-configuration to a flat closed position against the fuselage. The reels are locked once the plates are collapsed against the fuselage, and the tension in the control lines against the tension of the spring hinges keeps the wipers retracted flush against the fuselage. The bug wipers 110 are operated by the pilot only during flight when the sailplane is traveling at 40 to 60 knots, to ensure appropriate aerodynamic forces are generated by the wiper to deploy the wiper to the wing tip. At sailplane speeds greater than 60 knots, the control line is subject to failure due to the higher aerodynamic force generated by the wiper, resulting in the wiper flying off the end of the wingtip. At sailplane speeds less than 40 knots (or the sailplane stall speed, whichever is higher), the aerodynamic force is insufficient to move the wiper outboard along the wing and unreel the control line. Furthermore, at low speeds, the aerodynamic force generated by the wiper to hold it against the leading edge is insufficient to overcome the force of gravity on the wiper, resulting in the wiper falling off the wing's leading edge if the reels are unlocked at low speed.

The sailplane bug wipers 110 are manually deployed by the pilot by unlocking the reels, who determines the need to remove surface contaminations, and if the sailplane speed is within the operating envelop of the wipers. The pilot also manually retracts the wipers 110 by winding the reels. Furthermore, sailplane wings 100 are typically cleaned and waxed manually between flights. Sailplane wipers 110 also are not generally subject to the elements, such as ultraviolet rays, temperature extremes, and precipitation, other than during flight.

Sailplane wings 100 have a relatively constant airfoil shape, size and negligible twist from the root to the tip. Furthermore, the bug wiper's narrow operating envelope of sailplane speeds ensures the relative wind over a sailplane wing, and hence the developed aerodynamic forces on the sailplane bug wiper 110, are relatively constant from root to tip. Because sailplane wings do not rotate like wind turbine blades, the sailplane bug wiper 100 is not subject to variable direction gravitational force or any centripetal force.

In contrast to a sailplane wing, HAWT blades have a changing airfoil shape, size and twist along the length of the blade. A wiper on a HAWT is also subject to different operating conditions than a sailplane bug wiper, to include dynamic centripetal force, variable direction gravitational force, and changing relative wind direction and magnitude. HAWT blades also are exposed at all times after installation to the elements, and normally are not cleaned or waxed between uses. The variable shape and size of a HAWT blade would prevent an appropriately scaled bug wiper from conforming to and hence effectively cleaning the entire leading edge of a HAWT blade. Furthermore, the larger operating envelope of forces on a HAWT blade, to include dynamic centripetal, variable gravitational and changing relative wind direction and magnitude would further prevent successful use of a bug wiper on a HAWT blade; the bug wiper would fail to deploy in the low speed condition near the hub. If somehow a bug wiper were artificially deployed toward the tip of a HAWT blade, the control line would fail due to the high centripetal and aerodynamic forces. Finally, the bug wipers rely on manual inputs to include the decision to operate and the physical retraction of the bug wipers.

The system 14 of the present invention differ from sailplane bug wipers, in several aspects. First, the wipers 16 have pivot points 32, 34 between the pair of outboard arms 24, 26 and the inboard arms 28, 30, respectively, so that the arms can accommodate the changing dimensions of the blades 12 from root to tip, and the leading edge rotation twist from root to tip of approximately 90°. In addition to changing form to accommodate the dynamic physical characteristics of a HAWT blade, the wipers of the present invention also change form to accommodate the much larger operating envelope of forces and relative wind speeds generated by an operating HAWT blade as opposed to the relatively constant operating envelope a sailplane bug wiper is subject to. Specifically, the form of the present invention changes angle of attack, frontal area and surface area during operation to change the resulting aerodynamic force generated by the wiper. Also, in the preferred embodiment, the wipers 16 of the present invention are automatically deployed and retracted by the PLC. Furthermore, the wipers 16 are continuously subjected to the elements, including ultraviolet rays, temperature extremes, and precipitation. The system 14 also functions without frequent washing and waxing of the turbine blades 12, as in a sailplane wing.

Accordingly, a primary objective of the present invention is the provision of a system and method for removing debris from HAWT turbine blades.

Another objective of the present invention is the provision of a debris removal system and method for HAWT turbine blades which can be used while the blades rotate.

Another objective of the present invention is the provision of a system and method for cleaning contamination from the leading edge of HAWT turbine blades so as to allow maximum aerodynamic turbine performance at design specifications.

Still another objective of the present invention is the provision of a debris removal device and method which can be utilized on all types of HAWTs.

Yet another objective of the present invention is a HAWT blade cleaning system and method which eliminates power generation losses due to contamination of the blade surface.

Another objective of the present invention is the provision of a system and method for cleaning HAWT blades which can be automatically actuated.

Yet another objective of the present invention is the provision of a HAWT blade cleaning apparatus and method utilizing a programmable logic circuit which starts the cleaning process in response to input data from turbine sensors.

Another objective of the present invention is the provision of a system and method to remove debris deposits from HAWT blades without interrupting turbine operation; whenever required, and only when required, to ensure that the turbine blades remain free of debris at all times of operation; automatically, such that manual labor or additional equipment is not required to operate the device; but also manually, if desired; and without the need for water or solvents.

Another objective of the present invention is the provision of a system and method for removing debris from wind turbine blades which is economical to manufacture, easy to install, and durable and effective in use.

These and other objectives will become apparent from the following description of the invention.

### BRIEF SUMMARY OF THE INVENTION

The wind turbine blade debris removal system of the present invention includes blade wipers having first and second outboard arms extending partially around the blade on opposite first and second sides of the leading edge, and being pivotally connected to one another at a point in front of the leading edge so as to form to the shape of the blade. The wipers also include first and second inboard arms extending partially around the turbine blade on opposite first and second sides of the leading edge, and being pivotally connected to one another at a point in front of the leading edge so as to form to the shape of the blade. The first inboard and outboard arms are pivotally connected to one another on the first side of the blade by a first spring biased hinge, while the second inboard and outboard arms are pivotally connected to one another on the second side of the blade by a second spring biased hinge. A scraper element extends between the outboard arm on the first side of the blade and the inboard arm on the second side of the blade so as to engage the leading edge of the blade. The arms are moved along the blade from the root to the tip by aerodynamic and centripetal forces so that the scraper element scrapes the leading edge of the blade so as to remove debris deposits therefrom. The arms are retracted from the blade tip to the root by cables having outer ends attached to the outboard arms and inner ends attached to a rotatable spool adjacent the turbine hub.

A programmable logic circuit is operably connected to the cables for controlling deployment and retraction of the arms. The PLC receives data from sensors on the turbine and/or from a data link to automatically activate the cleaning system and process periodically as the turbine operates.

### BRIEF DESCRIPTION OF THE DRAWINGS

FIG. 1 is a perspective view showing a turbine with wipers partially deployed along the blades.

FIG. 2 is a perspective view showing the wipers fully retracted adjacent the hub of the turbine blades.

FIG. 3 is another perspective view showing the blades with wipers deployed for cleaning.

FIG. 3A is a partial side elevation view of one of the turbine blades showing a wiper in two positions, and a changing angle of attack of the wiper at each of the positions.

FIG. 3B is a front elevation view of the blade shown in FIG. 3A showing the changing angle of attack of the wiper arms adjacent the hub and adjacent the blade tip.

FIG. 4A is a cross-section view of the turbine mast and hub showing the mounting of the cable reel thereon.

FIG. 4B is an enlarged view of the retraction reel of FIG. 4A for retracting the wipers.

FIG. 4C is a view similar to FIG. 4B, but showing an alternative embodiment of a motor driven retraction of the wipers.

FIG. 5 is a schematic view of a HAWT blade with variable blade shape and leading edge twist along the length of the blade.

FIGS. 5A1-A2 show an elevation view and a sectional view of the cleaning wiper of the present invention when positioned at the root of the blade, designated as “a” in FIG. 5.

FIGS. 5B1-B2 are elevation and cross-sectional views of the cleaning wiper partially deployed at section b of FIG. 5.

FIGS. 5C1-C2 are elevation and sectional views showing the orientation of the wiper near the blade tip location c of FIG. 5.

FIGS. 6A and 6B are front and side elevation views, respectively, of a portion of the blade with the cleaning wiper deployed thereon, and showing the control cables attached to the wiper arms.

FIGS. 7A, 7B and 7C show a retraction reel design for the cleaning wipers that uses the HAWT's rotation to retract the wipers. FIG. 7A shows a non-operative condition of the wipers retracted to the hub as the cable reel rotates with the hub. FIG. 7B shows the reel unlocked from the hub and the wipers partially deployed along the blades. FIG. 7C shows the reel locked to the mast, with the cables winding up on the spool to retract the wipers.

FIG. 8 is a perspective view of the wiper of the present invention.

FIG. 9A is an elevation view of one of the outboard arms of the wiper, showing the changing angle of attack as the arm pivots.

FIG. 9B is an elevation view of one of the inboard arms, showing the changing angle of attack as the arm pivots.

FIG. 10A shows one position of the HAWT blades with defined x and y axes.

FIG. 10B is a series of schematics showing the gravitational force in two dimensional components for the x, y axes, as depicted for 0°, 90°, 180°, and 270° of blade rotation.

FIG. 10C shows the cosine wave corresponding to the gravitational force during continuous rotation of the blades from 0° to 270°.

FIG. 11A is a schematic view of a 3-bladed turbine.

FIG. 11B is a graph showing the magnitude of the Y component of centripetal force developed along a wind turbine blade as linearly proportional to the mass of the object and the distance from the hub, and exponentially proportional to the angular velocity of the turbine blades.

FIG. 11C is a graph showing the magnitude of relative wind speed along the HAWT blade of FIG. 11D, with constant angular velocity.

FIG. 11D is a schematic view of a turbine blade with an x axis aligned into developed relative wind for an operation HAWT, and showing the change in cross-sectional blade shape along the length of the blade.

FIG. 11E is a graph showing the magnitude of the Y component of aerodynamic force, with constant angular velocity.

FIG. 12 is a graph showing the sum of the Y component forces on a turbine blade having a constant angular velocity, with the sum forces corresponding to the solid line of the graph.

FIG. 13 is a diagram graphically depicting the logic used to initiate the debris removal system.

FIG. 14A is a sectional view showing the grease wick device according to the present invention.

FIG. 14B is an enlarged view of the grease wick.

FIG. 15 is a graph showing measured power output levels for a clean turbine blade and a debris contaminated blade.

FIGS. 16A-C show a top plan view, sectional view, and perspective view of a sailplane wing with a prior art bug wiper mounted thereon.

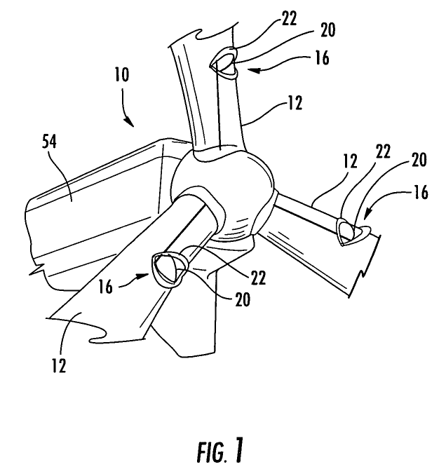

### DETAILED DESCRIPTION OF THE PREFERRED EMBODIMENT

A horizontal axis wind turbine (HAWT) 10 has a plurality of blades 12, as seen in the drawings. The structure of the turbine 10 and blades 12 is conventional and does not constitute a part of the present invention, and encompasses all types of HAWTs, including stall controlled-passive HAWTs having a fixed pitch, stalled control-active HAWTs having a variable pitch towards stall, pitch control HAWTs having variable pitch towards feather, and variable RPM HAWTs having constant tip-speed ratio and angle of attack.

The present invention is directed, in part, towards a system, generally designated by the reference numeral 14 in the drawings, which cleans or removes debris from the turbine blades 12. The basic components of the system 14 include a wiper 16, a reel 18, and a logic controller consisting of mechanical and electronic components that command and initiate deployment and retraction of the wipers 16.

Each wiper 16 includes a line or scraper element 20 and a line holder 22. The holder 22 includes first and second outboard arms 24, 26, and first and second inboard arms 28, 30. The outboard arms 24, 26 extend partially around the blade 12 and are pivotally connected to one another at a point 32 in front of the leading edge of the blade 12. Similarly, inboard arms 28, 30 extend partially around the blade 12 and are pivotally connected to one another at a point 34 in front of the leading edge of the blade 12. The pivotal connections 32, 34 allows the respective arms 24, 26 and 28, 30 to follow the contour, or changing dimensions of the blade 12 from the root 36 to the tip 38 of the blade 12.

A spring loaded hinge 40 pivotally connects the first outboard arm 24 and the first inboard arm 28. Similarly, a second spring loaded hinge 42 pivotally connects to the second outboard arm 26 to the second inboard arm 30. The hinges 40, 42 bias the connected arms 24, 28 and 26, 30 to an open or spaced apart position whereby the line or scraper element 20 contacts the leading edge of the blade 12.

The line 20 is connected to one of the outboard arms 24 or 26 on one side of the blade 12, and to one of the inboard arms 28, 30 on the opposite side of the blade 12, so as to extend around and engage the leading edge of the blade 12. The line or scraper 20 may be made of any material, such as nylon, having sufficient durability to remove debris from the leading edge of the blade 12, without creating excessive wear on the blade. Additional line 20 material is stored on thin spools mounted to the arms. The additional material enables the section of line 20 used to remove debris to be replaced with a new section of line after a set number of uses to guard against failure due to wear. Periodic replacement of the line also guards against failure due to extended exposure of the line to UV rays and other potentially harmful elements. Although not depicted in the Figures, the line 20 could comprise multiple sections of line, all connected in the same fashion as previously described. The use of multiple lines reduces the significance of a failure of any one of the individual lines, as the remaining lines continue to enable debris removal. The line spools are controlled with servo motors to enable remote, automatic replacement of the line 22 section as required.

The wipers 16 are positioned at the root 36 of the blade 12 adjacent the hub 44 of the turbine 10 when not in use. In this state, the outboard plate design acts as a protective cover for the other wiper 16 components, providing a barrier from the elements. Deployment and retraction of the wiper 16 along the blade 12 may be accomplished in several different ways. In a preferred embodiment, the wiper 16 moves outwardly from the root 36 to the tip 38 of the blade 12 due to the aerodynamic and centripetal forces generated on the holder 22 from the rotation of the blade 12. As the holder 22 moves outwardly along the blade 12, mechanical friction between the line 20 and the blade 12 scrapes debris from the blade surface. The pivotal connections 32, 34 between the outboard arms 24, 26 and the inboard arms 28, 30, respectively, allows the holder 22 to configure to the dynamic shape and size of the turbine blade 12 from root to tip, and thereby maintain sufficient force and contact area between the line 22 and the surface of the blade 12 so as to remove debris. The configuring of the outboard arms 24, 26 and inboard arms 28, 30 to the shape of the blade is a result of the relative wind acting on the holder 22. Specifically, the outboard arms 24, 26 and inboard arms 28, 30 collapse about the pivotal connections 32, 34 to meet the blade surface, in response to the aerodynamic forces generated by the holder 22.

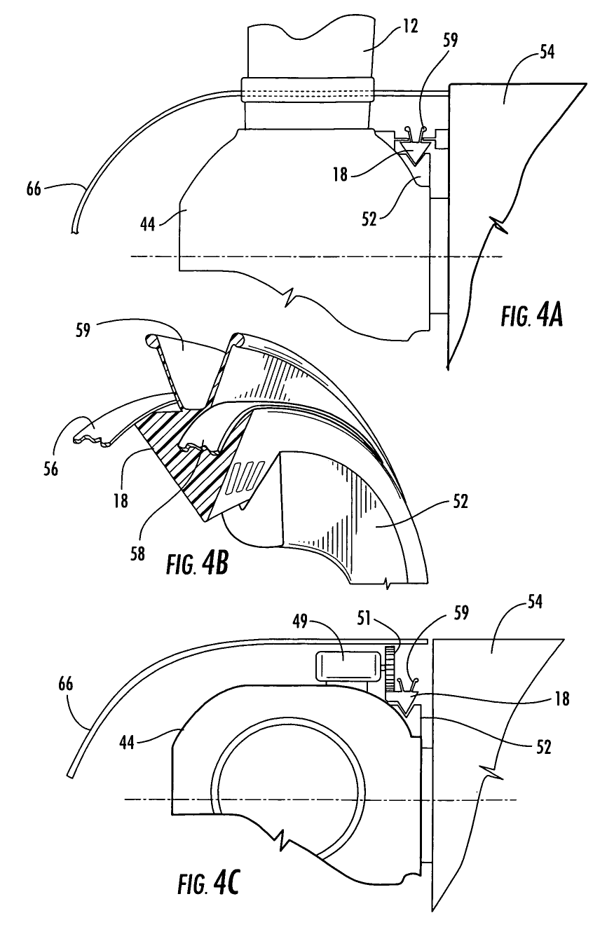

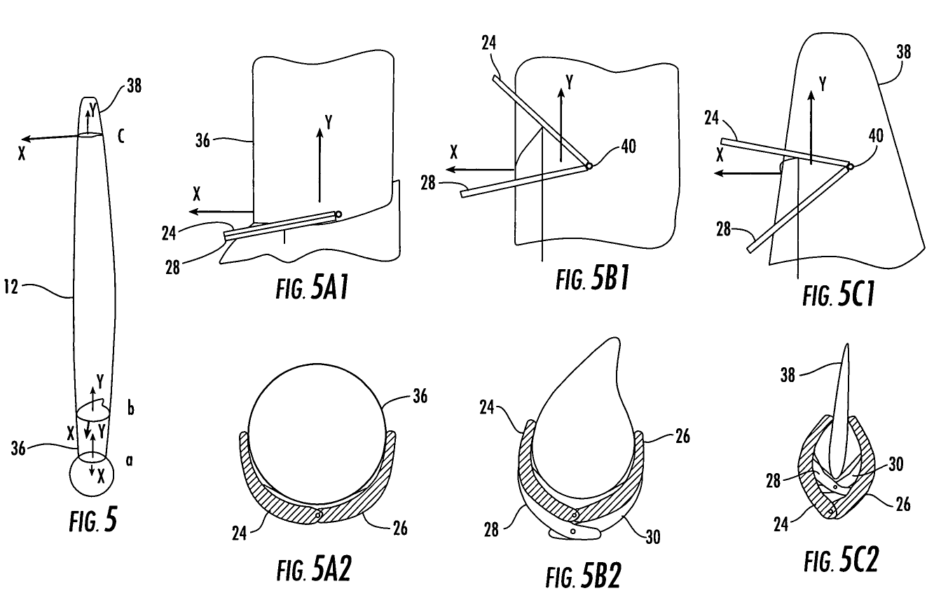

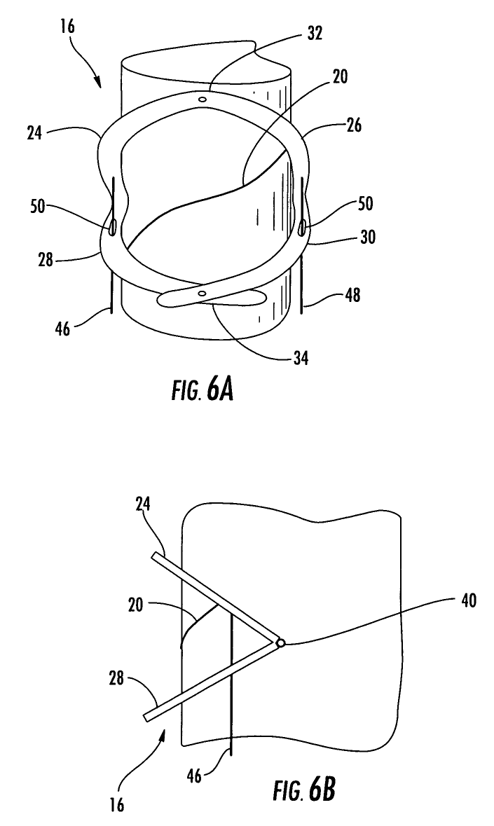

Three extreme configurations of the wiper 16 are shown in FIGS. 5A1-5C2. In FIGS. 5A1-A2, the wiper is located at the root 36 of the blade 12 in the retracted position. In FIGS. 5B1-B2, deployment of the wiper 16 has commenced, with the wiper in position a short distance from the blade root 36. In FIGS. 5C1-C2, the wiper is adjacent the blade tip 38.

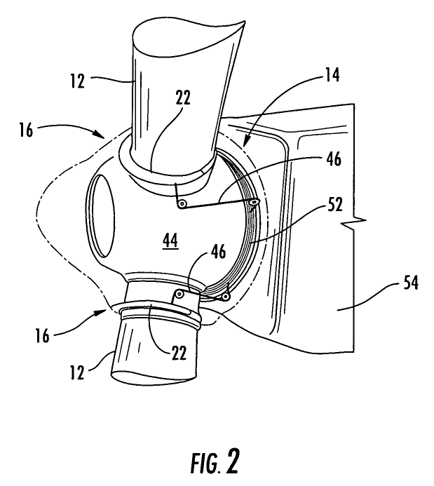

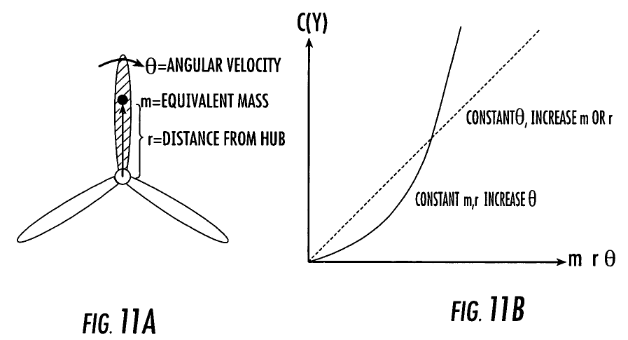

The operation of the turbine blade cleaning device of the present invention is a function of the forces which develop along HAWT blades 12 during typical operating conditions, including gravitational force, centripetal force, and relative wind speed, which will affect the aerodynamic forces of lift and drag generated by the holder 22. The gravitational forces on HAWT blades 12 are schematically shown in FIGS. 10A-C, wherein the y axis always points toward the tip of the selected blade and represents the blade span, while the x axis is directed along the chord of the blade, which for simplicity, disregards the twist in the blade chord. As the turbine rotates, the gravitational force, represented by the thick, downwardly directed arrow, includes x and y components at each blade position, as seen in FIG. 10B. Thus, the span-wise, y component of gravitational force, present along an operating HAWT blade 12 is described by the cosine wave depicted in FIG. 2c, at blade positions from σ=0° through 270°. The magnitude of the gravitational force is a function of the equivalent mass of the wiper described by the equation G(Y)=(cos σ)mg, where G(Y)=y-component of gravitational force, m=equivalent mass of wiper, and g=acceleration due to gravity.

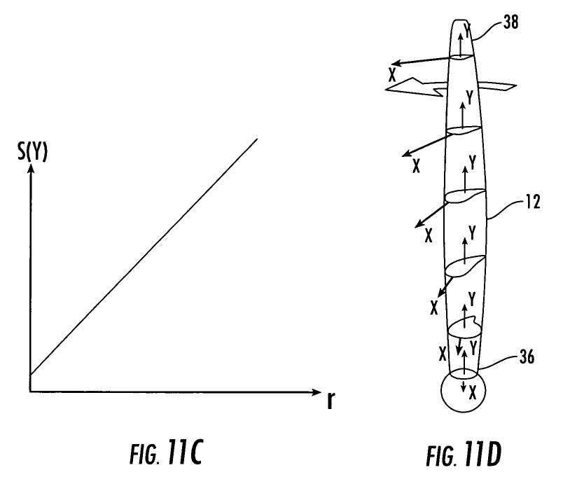

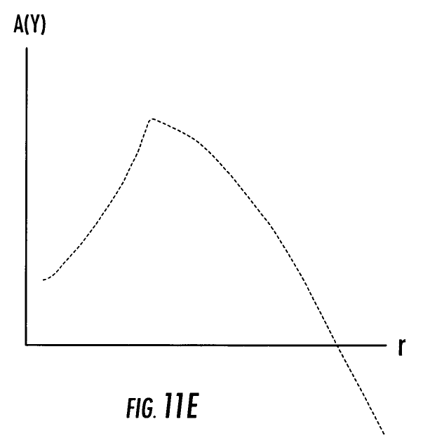

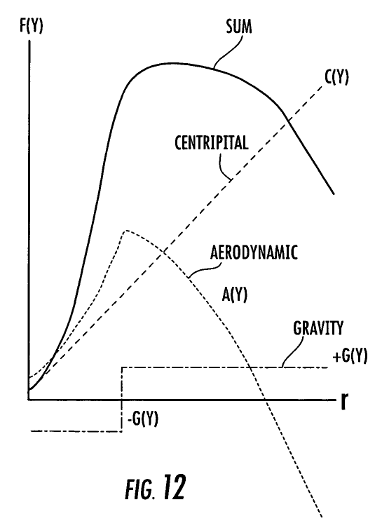

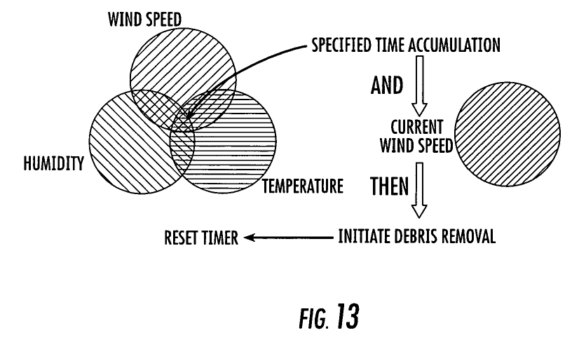

Using the x-y dimensional axis depicted in FIG. 10A, the centripetal force is developed along the y axis. The equation that describes the magnitude of centripetal force is C(Y)=mrθ², where C(Y)=y-component of centripetal force, m=equivalent mass of wiper, r=distance from the hub 44 to the center of the mass (m) and θ=angular velocity. From this formula, the magnitude of centripetal force is linear with respect to mass and distance from the hub, as seen in the sloped line in FIG. 11B, and exponential with respect to angular velocity, as seen by the curved line in FIG. 11B.

The two dimensional axis depicted in FIG. 11D, rotates about the y axis, such that the x axis is directed out of the page so as to be aligned into the relative wind developed when the wind turbine is operating. At the hub 44, where rotation has no effect on relative wind, the x axis points directly out of the page into the environmental wind. As the distance from the hub is increased along the blade span, the x axis will rotate towards the direction of rotation, such that at the tip of the blade, the x axis is nearly parallel to the page. The defined x axis, aligned with the relative wind, can therefore display the magnitude of the relative wind speed along the blade span, or y axis, which is

S(Y)=((θπr)²+(environmental wind speed)²)^{1/2}, wherein S(Y)=relative wind speed, θ=angular velocity, and r=the distance from the hub along the blade span.

The magnitude of relative wind speed along the wind turbine blade is plotted in FIG. 11C. For typical HAWT operation, in contaminated air, the most likely area of debris accumulation on the blade lies along the line through which the x axis depicted in FIG. 11D meets the surface of the blade 12.

The blade cleaning system 14 of the present invention is intended to clean the leading edge of the blades 12, which is the surface area with the highest probability of debris accumulation during operation of the turbine 10, and the area which will degrade aerodynamic performance, if contaminated. If contamination exists on the blades 12 outside the reach of the debris removal system 14, such contamination will not significantly adversely affect the performance of the HAWT.

The aerodynamic forces of lift and drag generated by the holder 22 from the relative wind are described by the formulas:

Lift Force=½ ρv² C_{L} A_{F}

Drag Force=½ ρv² C_{D} A_{F}
Where the lift coefficient, C_{L}=C_{LO}/(1+(C_{LO}/(ΠAR))), with C_{LO}=2Πα.
And where the drag coefficient, C_{D}=C_{DO}+C_{L}²/(.7ΠAR), with C_{DO}=1.28 sin α.
The Area Ratio, AR=S²/A, where A=Area (surface area of the holder 22) and S=Span (effective span of the holder 22).
Also, ρ=density of air, v=relative velocity, A_{F}=Frontal Area of the holder 22, and α=angle of attack (angle between the holder arms and the relative wind).

From these equations, it is evident that for a given relative wind, changes to the angle of attack, surface area and frontal area of the holder 22 enable changes in the generated lift and drag forces.

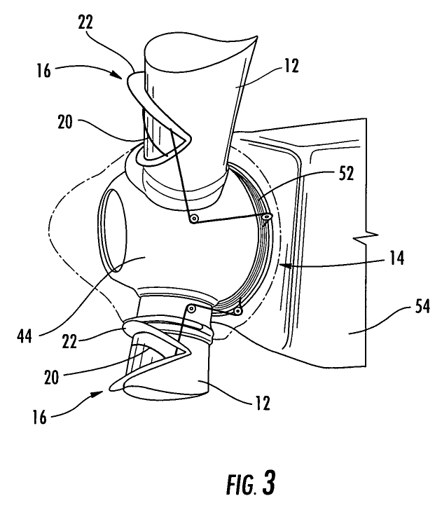

Initially, the primary force accomplishing deployment of the wiper 16 is the force of the spring loaded hinges 40, 42, which opens the outboard arms 24, 26 away from the hub 44. In this initial opened or unfolded condition, the frontal area and angle of attack of the inboard arms 28, 30 is less than the frontal area and angle of attack of the outboard arms 24, 26. Thus, when the relative wind meets the opened arms, aerodynamic forces are developed that force the arms against the blade 12 and carry the wiper 16 outwardly along the span of the blade 12. The initial aerodynamic force will also be sufficient to overcome any unfavorable gravitational force on the wiper 16. As the distance between the wiper 16 and the hub 44 increases, the centripetal force exerted on the wiper 16 increases, as depicted in FIG. 11B, thereby assisting in the deployment of the wiper 16. Also, as the wiper moves outwardly along the blade 12, the relative wind speed increases, as depicted in FIGS. 11C-D, thereby potentially increasing the aerodynamic force. Therefore, the holder 22 varies angle of attack, frontal area and surface area of the inboard 28, 30 arms and varies angle of attack and frontal area of the outboard arms 24, 26 to control the aerodynamic force, countering the increasing centripetal force. As seen in FIG. 3A, the angle of attack of the wiper arms 24, 26, 28, 30 varies as the wiper 16 moves along the blade 12. For example, when the spring hinges 40-42 open the arms during initial deployment of the wiper 16, the outboard arms 24, 26 have a greater angle of attack to the relative wind than the inboard arms 28, 30. The angle of attack substantially reverses as the wiper 16 moves outwardly to the tip 38 of the blade 12, wherein the angle of attack of the inboard arms 28, 30 is greater than that of the outboard arms 24, 26. This changing angle of attack indirectly results from the dynamic shape of the blade 12. As the holder 22 collapses about the pivotal connections 32, 34 to conform to the shape of the blade 12, the center of area of the outboard arms 24, 26 moves aft in relation to (and hence closer to) the connection point of the cables 46, 48 to the outboard arms 24, 26. In simplified terms, the center of area represents the center of lift and drag forces that act on the outboard arms 24, 26. The result is a reduced moment from the effective aerodynamic forces to the cable connection point, which in turn reduces the angle of attack of the outboard arms 24, 26. The moment of the outboard arm for an extended (A) and collapsed (B) state is depicted in FIG._9A_.

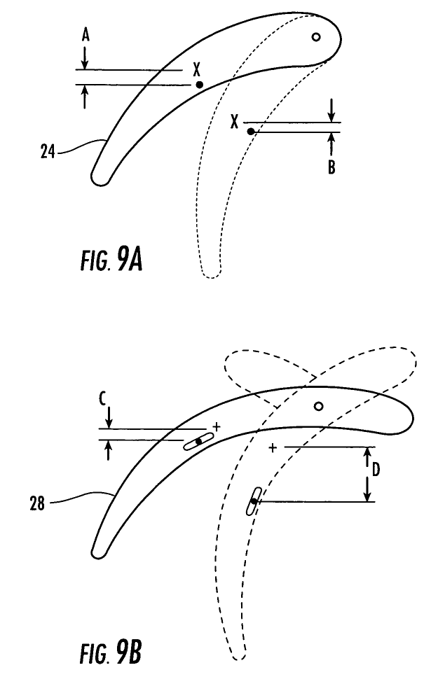

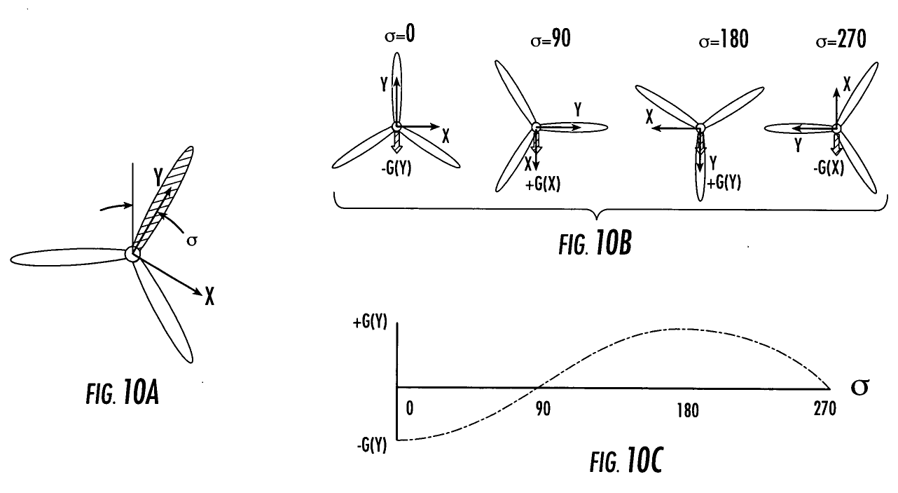

Concurrently, the center of lift of the inboard arms 28, 30 moves forward (and hence further from) the connection point of the cables 46, 48, as the inboard arms collapse about the pivotal connection 34. The forward movement is a result of additional surface area exposed by the inboard arms 28, 30, upwind of the pivotal connection 34. The result on the inboard plates is an increased moment from the effective aerodynamic forces, and thus an increase in the angle of attack of the inboard arms 28, 30. The moment of the inboard arm for an extended (C) and collapsed (D) state is depicted in FIG. 9B. The result of the changing angle of attack is a change in the magnitude and direction of the aerodynamic force on the wiper 16. In particular, near the hub 44, the aerodynamic force on the wiper 16 is outwardly towards the tip, and at the blade tip, the aerodynamic force is towards the hub 44.

The frontal area of the arms 24-30 also varies as the wipers 16 move along the blades 12. Generally, the frontal area effectively exposed to the wind decreases for the outboard arms 24, 26 as the wiper 16 moves outwardly along the blade 12, while the frontal area of the inboard arms 28, 30 increases. This area change reverses as the wipers 16 are retracted from the tip to the hub 44. The change in frontal area is a function of the changing angle of attack and the collapsing of the arms 24, 26 and 28, 30 to conform to the varying blade 12 shape from the root to the tip.

The resulting aerodynamic force generated by the holder along the blade span is depicted in FIG. 11E.

An alternative method (not shown) to generate the desired aerodynamic forces is to use a holder with control arms that incorporate moveable control surfaces, similar to an aircraft's control surfaces. In this alternative method, the control surfaces are positioned by remotely operated servo motors. The end result of the use of control surfaces in the alternative method is the same as the preferred embodiment; changing angle of attack, surface area and frontal area to generate desired aerodynamic forces on the holder.

The component of aerodynamic force back against the blade, along the chord of the blade, ensures sufficient friction for the line 20 to remove debris from the blade surface, but not so much friction as to prevent deployment or retraction of the wiper 16. Therefore, the aerodynamic design of the holder 22 also ensures an appropriate aerodynamic force component along the chord-axis through the range of deployment and retraction of the wiper 16.

The net span-wise force on the wiper during deployment, despite the reversing of the span-wise aerodynamic force from outboard to inboard, will still be outboard due to the overwhelming centripetal force, as depicted in FIG. 12. Therefore, to prevent the wipers 16 from continuing outboard beyond the tip of the blade 12, two cables 46, 48 extend through slots 50 in the inboard arms 28, 30 and attach to the outboard arms 24, 26. The cables 46, 48 limit the travel of the wiper 16 along the span of the blade 12 during deployment and provide a means to retract the wiper 16. The cables 46, 48 also serve to stabilize the wiper 16 travel along the leading edge of the blade. The stabilizing action of the cables is required at the base of a HAWT blade with a circular cross section, when the wiper arms are most extended about the pivotal connections 32, 34, and the wiper is most susceptible to sliding around the blade, away from the blade leading edge. The equal lengths of cable 46, 48 attached to each first and second arms on opposite sides of the blade leading edge prevents the wiper 16 from sliding around the blade. As the wiper 16 travels along the blade towards the tip and the wiper arms collapse about the pivotal connections 32, 34 to conform to blade, the wiper naturally stabilizes about the blade leading edge. The cables 46, 48 are reeled in until the inboard arms 28, 30 engage the hub 44 and the outboard arms 28, 30 are closed against the inboard arms 28, 30, overcoming the bias of the hinges 40, 42. Thus, when the cables 46, 48 are completely retracted, the arms of the holder 22 are folded closed, as seen in FIG. 5A1 and FIG. 2.

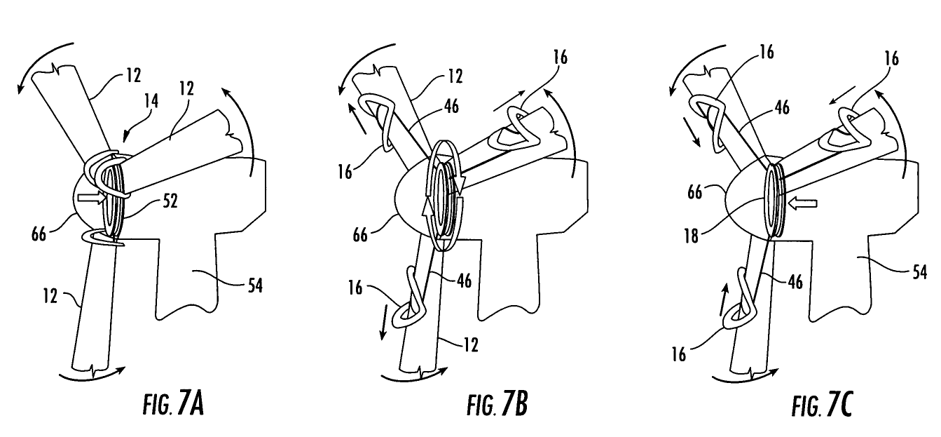

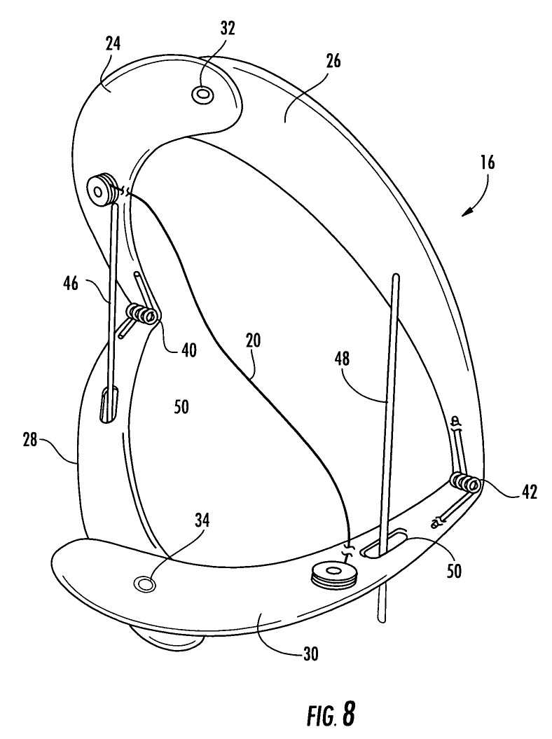

Various means can be used to control the deployment and retraction of the cables 46, 48. One control embodiment is shown in FIGS. 7A-C, wherein the energy to reel in the cables is derived from the rotating motion of the HAWT. As seen in FIG. 7A, when the wipers 16 are in the non-use or storage position adjacent the hub 44, the cables 46, 48 are fully reeled in so that the tension of the cables maintain the wipers 16 in their non-functioning position. The cables 46, 48 are wound about the reel spool 18, which is locked to the hub 44 in any convenient manner, such that the reel 18 rotates at the same rate as the hub 44 and prevents unwinding of the cables 46, 48. When it is desired to deploy the wipers 16, the reel 18 is unlocked from the hub 44, permitting the reel to rotate opposite the hub and thereby allow the cables 46, 48 to unwind as the aerodynamic and centripetal force acting on the wipers 16 effective pull the wipers outboard along the span of the blades 12, thereby unwinding the cables 46, 48 from the reel 18. When the wipers 16 reach the blade tips 38, the cables 46, 48 are fully unwound, such that the reel 18 stops unwinding and resumes rotation at the same rate as the hub 44.

To accomplish retraction of the wipers 16, the reel 18 is locked to the mast 54 of the turbine 10, as shown in FIG. 7C. As the hub 44 continues to rotate, the cables 46, 48 are wound around the reel 18, effectively reeling the wipers 16 inboard along the blades 12. The reel or spool 18 remains locked to the mast 54 until the wipers 16 are retracted flush against the hub 44, at which time the reel 18 unlocks from the mast 54 and locks to the hub 44, returning to the state depicted in FIG. 7A.

The locking of the reel or spool 18 to the hub 44 or the mast 54 can be accomplished by various means. For example, in a preferred embodiment, the reel 18 is locked using a servo-actuated clutch, with sensors which activate opening and closing of circuits for the clutch. When the cables 46, 48 are completely unwound from the reel 18, a sensor closes the circuit to activate the clutch system between the reel 18 and the mast 54, thereby initiating the retraction of the wipers 16. Also, once the wipers 16 are retracted flush against the hub 44, another sensor opens the circuit, releasing the reel 18 from the mast 54, while simultaneously locking the reel 18 to the hub 44. A solar-charged battery may be used to provide power for the operation of the sensors, servos, and programmable logic circuit, or use of electrical power directly from the HAWT.

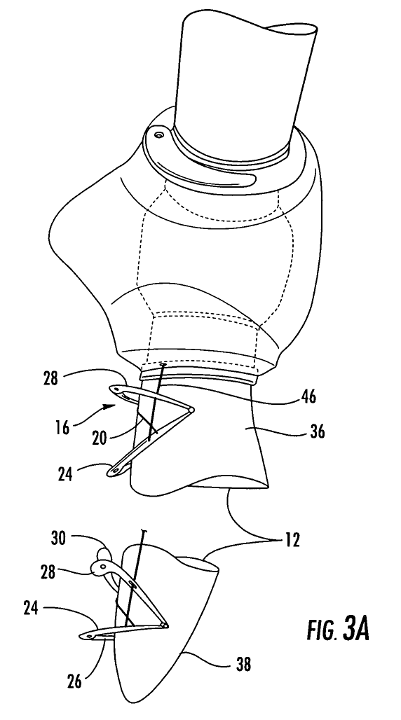

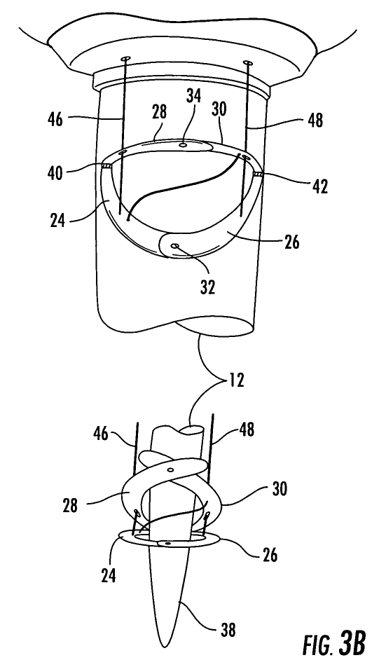

More particularly, the reel 18 is locked to the mast 54 and hub 44 by a pair of clutches 58, 56, as best seen in FIG. 4B. Preferably, the clutches 56, 58 are friction-type clutches, which tend to reduce coupling shock by slipping during engagement. The friction-type clutch may be an axial-disk, rim over running, or rim band-type.

In the preferred embodiment, a reel guide 52 is mounted to the hub and has a perimeter groove for receiving the reel 18. The reel 18 is rotatable within the groove of the guide 52, which may include roller bearings to minimize friction between the reel 18 and the guide 52. The depicted clutches are rim band type clutches 56, 58 surrounding the reel 18. To “clutch” the reel 18, a servo motor controlled by the PLC moves an arm (not shown) attached to the clutch band 56 or 58, so as to reduce the circumference of the band so that the band frictionally engages the reel 18, until the reel's relative motion to the band stops. Only one clutch 56, 58 is actuated at a time. The hub clutch 56 is normally engaged at all times when the wipers 16 are not deploying or retracting, thereby maintaining the cables 46, 48 wound and tensioned on the reel 18 so that the wipers 16 remain in the retracted position. When both clutches 56, 58 are released or disengaged, wipers 16 are deployed, so as to travel outwardly along the blades 16 to clean debris from the leading edge of the blades. The aerodynamic and centripetal forces exerted on the wipers 16 unreel the cables 46, 48 from the reel 18 when the clutches 56, 58 are disengaged. When the wipers 16 are to be retracted, the mast clutch 58 is engaged so as to frictionally engage the reel 18, such that the reel 18 is held against rotation relative to the rotating hub 44, whereby the cables 46, 48 are wound back onto the reel 18, and thereby pulling the wipers 16 back toward the hub 44. The reel 18 includes a perimeter channel 59 for collecting and storing the cables 46, 48. The cables 46, 48 are routed from the reel 18 to the blade-hub junction using any convenient means. In the preferred embodiment, the cables 46, 48 are routed using pulleys.

Another alterative for reeling in the wipers 16 is the use of an electric motor 49 to drive the reel 18, as shown in FIG. 4C. A toothed gear 51 on the motor 49 meshes with teeth on the reel 18 to retract the wiper 16 when the motor is actuated. In this embodiment, the reel 18 is not locked to the mast 54 during retraction. A spring may be provided on the reel 18, so as to store energy from the unwinding reel as the wipers 16 are deployed, thereby counteracting the linearly increasing centripetal force. The loaded spring can then reduce the power required, and hence the motor size and electric power drain, when the wipers 16 are reeled in. This embodiment eliminates the need for clutches, servos, and sensors, by using a timed motor operation. Electricity for the motor may be provided by batteries charged by solar panels, or use of electrical power directly from the HAWT.

In yet another embodiment (not shown), the turbine blades 12 can be cleaned when the turbine is in an operative or inoperative state, through the use of friction for moving the wipers, as opposed to aerodynamic and/or centripetal forces. In this embodiment, the wipers 16 will incorporate motor driven wheels that track along the span of the blades 12 to move the wiper 16 along the blade. If this system is used when the turbine is stationary, the friction force required and the power necessary to deploy and retract the wipers 16 will be minimal, compared to the friction and power requirements when the turbine is rotating. The motors may be remotely controlled, or may include hard wiring between the hub 44 and the wipers 16.

In still another design variation, an aerodynamic surface with attached cables can be sent out from the hub along the blade, and once in place, a separate wiper component can be deployed, guided by and crawling along the cables. Once the wiper completes debris removal, the surface holding the cables is retracted.

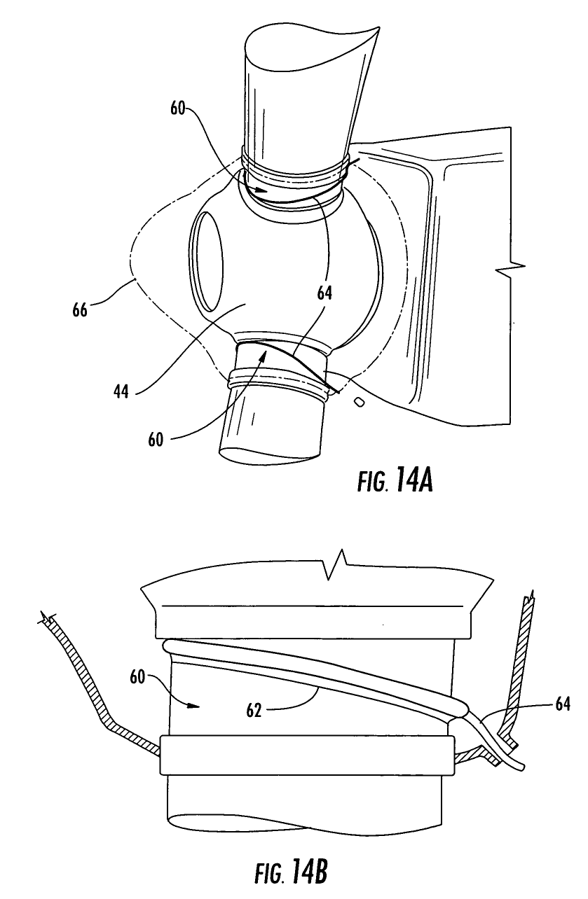

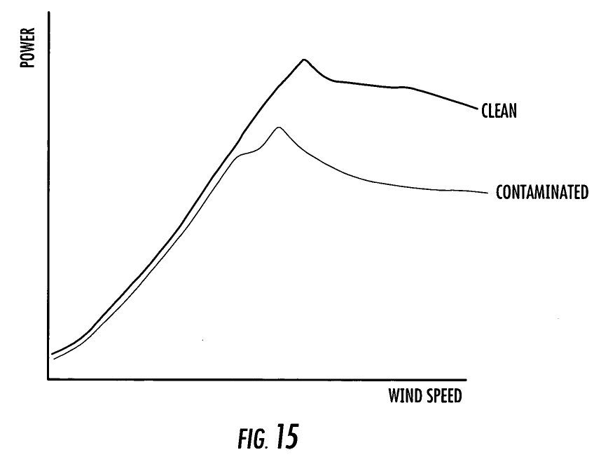

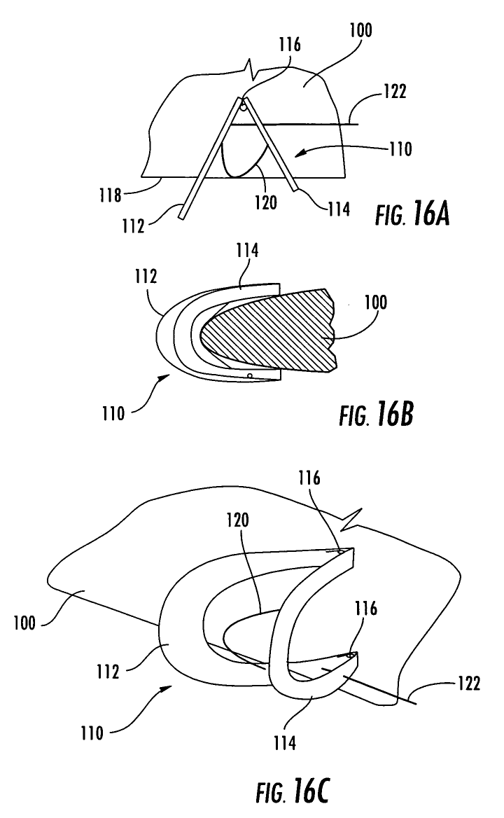

In all embodiments, the debris removal system 14 also incorporates a programmable logic controller (PLC), which permits automatic operation of the system 14 by providing the logic to trigger actuation of the wipers 16 at appropriate times. A three-position switch commands the PLC modes between automatic, off, and manual. The PLC receives weather data and operating conditions from sensors on the wind turbine 10 or sensors at the wind turbine farm via data link. The PLC is programmed to initiate debris removal when the received data indicates a high probability for debris accumulation, if the switch is set to automatic. The PLC will track the time accumulated within a specified temperature, humidity and wind speed range. After the determined amount of time has accumulated, the PLC checks the current turbine speed or wind speed, depending upon available data. If the current turbine/wind speed falls within the specified range, the PLC will initiate the debris removal of system. If the current turbine/wind speed does not fall within the specified range, the PLC will refrain from initiating the debris removal system until the specified condition is met. Once debris removal is initiated in the automatic mode, the time accumulation clock is reset. FIG. 13 provides a graphic depiction of the logic used in the PLC.

The logic design for the automatic mode ensures the debris removal system operates whenever debris accumulation has occurred, as soon as the turbine is operating within limits that will permit safe, effective operation of the debris removal system. The specified temperature, humidity and wind speed ranges set in the PLC is based on the ranges which insects are expected to or able to fly, which overlap with the wind speeds that permit HAWT operation. For example, if the wind speed is below the wind turbine cut in speed, insects may be flying, but the turbine is not operating and therefore, debris accumulation is unlikely and no logic time accumulation occurs. As another example, a higher wind speed may permit turbine operation, but prevent insects from flying, so that debris accumulation is unlikely, and no logic time accumulation occurs. Similarly, for low temperature and/or humidity conditions, the turbine may be operating, but insect debris accumulation is unlikely, and no logic time accumulation occurs.

Temperature, humidity and their interaction are the most important weather components of insect activity. The insects of concern are those capable of flight, and thus a third weather component, wind speed, also affects insect activity. The temperature extremes of insect activity are referred to as the upper and lower developmental threshold temperatures. The specific range of weather conditions is unique to each insect species, and thus the PLC can be set accordingly for the location of the HAWT and the corresponding insect species of concern.

When the PLC is set to the manual mode, debris removal is initiated as soon as the current wind speed is within the specified envelope. Once deployment is initiated in the manual mode, the switch must be reset to accomplish additional debris removal cycles. The manual mode allows an individual to accomplish debris removal on demand.

Another problem associated with variable or controlled pitch HAWTs, though not on fixed pitch HAWTs, is the leakage of grease from the blade-hub junction onto the blade. Such grease deposits can be removed by the wipers 16 if located on the leading edge of the blade, similar to other debris contamination, but cannot be removed by the wipers 16 if located on other surfaces of the blade 12. While grease deposits on these other blade surfaces do not have a significant impact on performance of the turbine, these deposits detract from the turbine appearance. To prevent such grease deposits, the cleaning system 14 can be fitted with a grease control system 60 which prevents grease deposits on the blades 12. The grease control system 60 includes an absorbent, yet wicking material extending around the hub 44 for collecting grease from the blade-hub junction, and a terminal wick 64 to direct the collected excess grease for discharge away from the blades 12.

Grease control system 60 of the present invention is best shown in FIG. 4A-B. When the turbine 10 is not operating, the downwardly pointing blade may leak grease as gravity pulls the grease or oil from the hub 44 towards the tip 38 of the blade 12.

During operation of the turbine 10, centripetal force may also drive grease out of the hub 44, which is also transported by the wick 64 to the terminal wick 62 end for dripping away from the blade 12 and the hub 44. The collection wick 64 extends around the blade 12, preferably inside the fairing 66, so as to absorb and wick the grease away from the blade 12. The wick 64 is wrapped tightly around the blade 12 so as to preclude grease or oil from passing between the wick 64 and the blade 12. A bead of silicone may also be applied to the blade 12 adjacent the wick 64 on the side of the wick 64 opposite the hub 44 to further assist in preventing any pass through of grease or oil beneath the wick 64. The wick 64 extends at an angle around the blade 12, so that the grease will flow by gravity along the wick 64 to the terminal end where the grease or oil may drip free from the hub 44 and clear of the blade 12.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A system for removing debris from a wind turbine blade, having a root, a tip a leading edge, and blade surfaces extending rearwardly from the leading edge, comprising:
a wiper having inboard and outboard members moveable between open and closed positions;
a first spring biased hinge pivotally connecting the inboard and outboard members;
a scraper element extending between the outboard and inboard members so as to engage the leading edge of the blade as the wiper moves along the blade; and
each of the inboard and outboard members having dynamic shapes which change so as to follow the blade surfaces.

2. The system of claim 1 further comprising first and second cables having first ends secured adjacent the root of the blade and second ends secured to the outboard members to retract the members along the blade.

3. The system of claim 2 further comprising slots in the first and second inboard members through which the first and second cables pass, respectively.

4. The system of claim 2 further comprising a reel adjacent the blade root upon which the cables are wound.

5. The system of claim 1 further comprising a programmable logic circuit operatively connected to the cables for controlling activation of the arms.

6. The system of claim 1 wherein the outboard member includes first and second outboard arms extending partially around the blade on opposite first and second sides of the leading edge and being pivotally connected at a point in front of the leading edge; and the inboard member includes first and second inboard arms extending partially around the blade on opposite first and second sides of the leading edge and being pivotally connected at a point in front of the leading edge.

7. A method of cleaning debris from a leading edge of a wind turbine blade having a root and a tip, comprising:
positioning a pair of first and second outboard arms partially around the blade on opposite first and second sides of the leading edge;
positioning a pair of first and second inboard arms partially around the blade on opposite first and second sides of the leading edge;
extending a scraper element between the outboard arm on the first side of the blade and the inboard arm on the second side of the blade so as to engage the leading edge;
as the turbine rotates, allowing the arms and scraper element to move outwardly along the blade from a first position adjacent the root to a second position adjacent the tip so that the scraper element scrapes debris from the leading edge of the blade.

8. The method of claim 7 further comprising retracting the arms and scraper element from the second position to the first position.

9. The method of claim 8 wherein the retracting is accomplished using a cable secured to one of the outboard arms.

10. The method of claim 7 wherein the arms and scraper element move outwardly by aerodynamic and centripetal forces.

11. The method of claim 7 further comprising changing the angular relationship between the first and second outboard arms and the angular relationship between the first and second inboard arms as the scraper element moves between the first position to the second position.

12. The method of claim 7 wherein the movement of the arms and scraper element is automatically initiated.

13. The method of claim 12 wherein the movement is initiated in response to data received from a weather data sensor.

14. The method of claim 13 wherein the movement is initiated by a programmable logic circuit.

15. A method of cleaning a wind turbine blade, comprising:
deploying a scraper element engaging a leading edge of the blade while the turbine is rotating so as to move outwardly by aerodynamic and centripetal forces from a first position adjacent the blade root to a second position adjacent the blade tip; and
retracting the scraper element to the first position.

16. The method of claim 15 wherein the retraction is accomplished by a cable attached to an arm to which the scraper element is attached.

17. The method of claim 15 wherein the retraction is controlled by a servo-actuated clutch system.

18. The method of claim 15 wherein the deployment and retraction is performed automatically.

19. The method of claim 15 wherein the deployment and retraction is controlled by a PLC.

20. A system for preventing grease deposits on a blade of a turbine, the blade being mounted on a hub of the turbine, the system comprising:
a wick wrapped around the blade adjacent the hub so as to catch grease from the hub and prevent migration of the grease onto the blade.
